(19) United States
(12) Patent Application Publication
(10) Pub. No.: US 2005/0094929 A1
(43) Pub. Date: May 5, 2005

(54) Process for optical and electro-optical switching

(76) Inventor: Frank W. Johnson, Beulah, MI (US)

Correspondence Address: Frank W. Johnson, 5785 Van Deman Pl., Beulah, MI, 49617, US

(21) Appl. No.: 10/698,644

(22) Filed: Nov. 3, 2003

(51) Int. Cl. G02B 6/26

(52) U.S. Cl. 385/16

(57) ABSTRACT

A process for converting multiple optical or electro-optical on/off switches or electro-optical modulators into an electro-optical switch or a 2×2 or 4×4 . . . or 2″−2″ cross switch.

### CROSS-REFERENCES TO RELATED APPLICATIONS U.S. PATENT DOCUMENTS Pat # 5,420,946 . . . May 30, 1995 Tsai . . . 385/22; 385/26; 385/16; 385/47 Patent app.#20030179985

### STATEMENT REGARDING FEDERALLY SUPPORTED RESEARCH OR DEVELOPMENT

There was no federal support in research or development

### BACK GROUND OF THE INVENTION

The field of endeavor of this invention is in the process of switching fiberoptic data paths. In directing a message in an all optical network (AON), you either convert to an electrical signal and then back to optical signal (OEO), or you switch the optical beam itself between different channels. See, for example, U.S. Pat. No. 5,420,946, Tsai, “A MULTI CHANNEL COUPLING DEVISE”. This consists of a 90 degree, rotating central mirror, a control system, and multiple fiberoptic inputs arranged in a circle around the central mirror. There are a variety of other mechanical ways of doing this; the most famous is the electrostatic switching controlling multiple very small mirrors (MEMS}. Though very successful, there are still very large latencies in milliseconds or parts of milliseconds. My patent is for an optical or electrically controlled optical switch that is very fast and entirely non-mechanical.

One of the most important problems of optical networks is that no one has developed a way to switch active light beams, really fast. It is relatively easy to send a large amount of data across the continent on a lambda of light. But in order to collect it at one end and deliver it at the other end it must be switched optically or converted to an electrical signal and at the other end reconverted to an electrical signals. About five years ago, I discovered that, if you could turn a light beam off optically or electrically, you could build an output switch according to this patent claim. No patent was filled because there was at that time no way to turn a light beam off. As soon as the News Brief (Paulson “IEEE COMPUTER,” cited above) of the Heflin article appeared, I figured out you could use their devise as an on-off switch for a light beam and that my invention was now a practicality and I am now filling this patent.

There is an interesting patent application #20030179985. This claims an optical switch having the light go through a variable refractive material. There are 68 claims of different ways to change the refractive index including a case where the wave length is transmitted or substantially reflected; refractive material is changed by electric field, magnetic field, a controlled light or temperature; or an event without moving (15). All of these seem to be variations of claim (1) a variable refractive material, but no details of what that material would be.

In any event, the invention that precedes this one and makes my switching process more feasible is the above cited, Randy Haflin's work at Virginia Tech University printed in Computer magazine, October, 2003, copy enclosed under the cross-references. See FIG. 1. This is an electro-optical modulator used to impress a digital signal on an optical beams at around 100 Gbits/ sec. The devise they describe splits the light beam or Lambda into two identical paths covered with Procion Red dye (see picture in article). One path has a top and bottom electrode on which the digital signal if impressed. The applied signal voltage slows the light transmission one half wavelength of the light beam so that it is 180 degrees out of phase. When the beams are recombined, if the voltage is off they join in phase, but if the voltage is on, the out of phase voltage and the in phase voltage cancel and produce no output. In this way the digital pulses are modulated on the wave. The voltages used were around 10 volts.

### BRIEF SUMMARY OF THE INVENTION

This invention has two parts. The first part is that you can build a process for switching a light beam, by being able to turn off one of a pair of identical light paths.

The second part is a more specific embodiment. I convert two or more electro-optic modulators into a fiberoptic switching process by impressing a constant voltage which you can turn on and off. This switch is a very rapid (up to 100 GHz/second) on-off switch of an optical beam. You divide the light beam into two identical input streams (a and b) and one output (c or d). With two electro-optical modulators in parallel, and a control circuit that activates one or the other but not both or neither electro-optical modulators, you have a light beam switching process. See FIG. 3. The light beam travels through the electro-optical modulator in which the control voltage is turned off and not down the one that is turned on. By using 4 or more switches we have an electrically controlled process for switching an optical beam in a 2×2, a 4×4 . . . or.2″−2″ cross switch.

### DETAILED DESCRIPTION OF THE INVENTION

There are two parts to this optical switching process. The first is that you can create a light beam switching process if you are able to shut off a light path with an electronic or optical control. You divide the light path into two parts. With a control circuit you turn off one part but not the other part of the light beam. You now have a generalized light switching process. If the controls and the on/off medium are rapid you will have a rapid optical or electrically controlled light switching process.

The second part of this invention is a specific process for using a series of electro-optic modulators for a fiberoptic switching process. If, instead of impressing a pulse you impress a constant voltage which you can turn on and off on the fiber-optic modulator, you have created an electro-optical switching process, achieving a very rapid (up to 100 GHz/second) switching of an optical beam. If you have two electro-optical modulators in parallel, and build a control circuit that activates one or the other but not both or neither electro-optical modulator; you have built an optical path switching process that is fast and electronically controlled See FIG. 3. This will send the light beam through the electro-optical modulator in which the control voltage is turned off and not down the one that is turned on. Now you have created an optical beam switching process, electrically controlled. With this electro-optical switching process and a control circuit, you can build a 2×2, a 4×4 . . . 2″×2″ cross switch where every input can be switched exclusively to any other output, and because it is non-mechanical it is much faster than any current mechanical switch.

With this switching process you can do several things:
1. Switch a fiber-optic light beam, or
2. Switch a lambda of a fiber-optic light beam, or
3. Create a 2×2, a 4×4 . . . 2″×2″ cross switch where every input can be switched exclusively to any other output, or
4. The switch configuration could be held for a defined time period (1 microsecond, 1 second, a minute, a day or weeks), or
5. Could be switched in a burst mode, or
6. Could be switched in a Time Division Multiple Access mode.

### DRAWINGS

FIG. 1 is the drawing of the fiberoptic modulator of Associate Professor Randy Heflin, Virginia Tech University, which is the key component of one of the embodiments of my invention. It is Professor Heflin's modulator that is used in the switching process. It is not part of my claim. 1 shows the Procion dye surface of the modulator. 2 is the output light beam. 3 points to the two electrodes that produce the electrical gradient that modulates the output 2. 4 is the input light beam, that is to be turned on or off.

FIG. 2 is a schematic of the off-on switch in the optical switching process. When a stable DC Voltage is applied, the on-off optical switch is off, and when the voltage is removed the switch is on.

FIG. 3 is a schematic of the optical switching process. It shows one unit of the optical switching process. The control circuit feeds either e or f with an approximately 10 volt DC. And either c or d is the output circuit. We have thus sent the input beam into either c or d outputs at the direction of the control circuit.

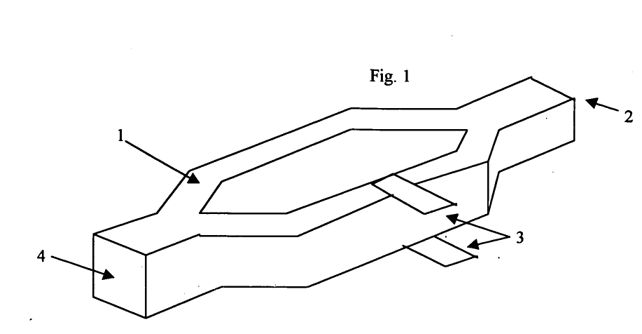

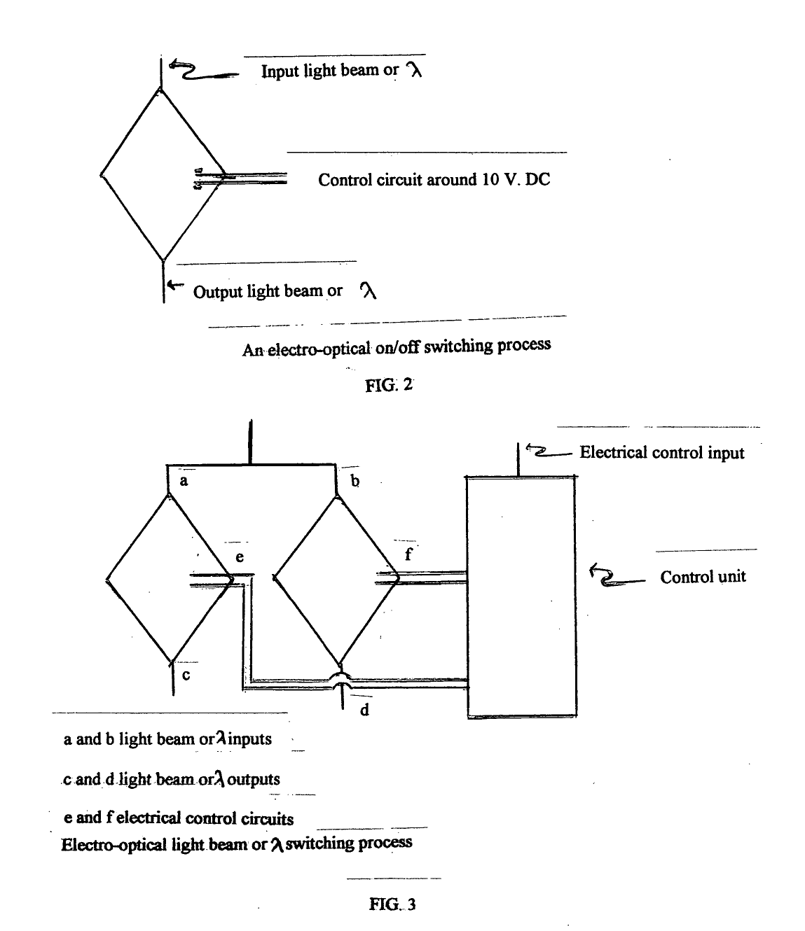

1. A process for converting any optical or electro-optical on-off switch into an electro-optical switching process by pairing two of them with a flip-flop control system, and
a) a switching process for switching a lambda of a fiber-optic light beam, and
b) by using 2 or more switches and a control circuit, create a 2×2, a 4×4 . . . 2″×2″ cross switching process, where every input can be switched exclusively to any other output, and
c) The switching process configuration could be held for a defined time period (1 microsecond, 1 second, a minute, a day or weeks), or
d) The optical or electro-optical switching process could be controlled by a burst mode control system, or
e) The switching process could be controlled by a Time Division Multiple Access mode, and
f) other uses for this optical switching process, and
g) The optical switching process could be a component of a small scale or a large scale integrated optical control circuits, having a least one optical switching process of claim 1), however built.

2. A switching process using one or more electro-optic modulators for an optical beam switch, and
a) switching process for switching a lambda of a fiber-optic light beam, and
b) by using 2 or more optic modulators and a control circuit, create a 2×2, a 4×4 . . . 2′×2′ cross switching process where every input can be switched exclusively to any other output, and
c) the switching process configuration could be held for a defined time period (1 microsecond, 1 second, a minute, a day or weeks), or
d) the switching process could be controlled by a burst mode control system, or
e) could be controlled by a Time Division Multiple Access mode.
